(19) United States
(12) Patent Application Publication
(10) Pub. No.: US 2013/0069284 A1
(43) Pub. Date: Mar. 21, 2013

(54) APPARATUS FOR MAKING PERFORATIONS IN A PACKAGING MATERIAL AND METHOD OF ADJUSTING SUCH AN APPARATUS

(71) Applicant: Martijn Willem De Bruin, Kockengen (NL)

(72) Inventor: Martijn Willem De Bruin, Kockengen (NL)

(73) Assignee: PERFO KNOWLEDGY BV, Brielle (NL)

(21) Appl. No.: 13/700,738

(22) PCT Filed: May 26, 2011
(86) PCT No.: PCT/EP2011/058619

§ 371 Date: Nov. 29, 2012

(30) Foreign Application Priority Data
Jun. 1, 2010 (EP) 10164641.2

(51) Int. Cl. B26F 1/00

(52) U.S. Cl. CPC B26F 1/0084
USPC 264/400; 425/135

(57) ABSTRACT

The invention relates to an apparatus (1) for making perforations in a packaging material, in particular a polymer film (2), comprising a conveyor for transporting the material (2) along a path through the apparatus (1), a laser device (7) with adjustable focal point, and an in-line optical detector (8) for measuring one or more parameters of the perforations made with the beam. The apparatus further comprises a controller (10) connected to the laser device (7) and the detector (8) and arranged to adjust the focal point of the laser device (7) based on the parameter(s).

The invention relates to an apparatus for making perforations in a packaging material, in particular a polymer film, comprising a conveyor for transporting the material along a path through the apparatus, e.g. from a supply reel to a take-up reel, a laser device, with adjustable focal point, and an in-line detector for measuring one or more parameters of the perforations made with the beam, in particular an optical detector such as a (digital) camera. The invention further relates to a method of adjusting such an apparatus.

As explained in U.S. Pat. No. 7,083,837, the quality and shelf life of many food products is enhanced by enclosing them in packaging that modifies or controls the atmosphere surrounding the product. Increased quality and longer shelf life result in fresher products for the consumer, less waste from spoiled produce, better inventory control, and appreciable overall savings for the food industry at both the retail and wholesale levels. The goal in fresh fruit and vegetable packaging is to use modified and controlled atmosphere packaging (MAP/CAP) to preserve produce quality by reducing aerobic respiration rate yet avoiding anaerobic processes that lead to adverse changes in texture, flavor, and aroma, as well as an increased public health concern. U.S. Pat. No. 7,083,837 discloses a microperforation system wherein a stationary laser beam drills the microperforations in a target area of a film, as the film is moving.

WO 02/12068 relates to a method for packaging products prone to decay, wherein a synthetic foil is conveyed through a (laser) punching device, where perforations are punched in the synthetic foil, the perforated synthetic foil is formed as packages having the desired dimensions and these packages are filled with the products and closed. The perforation surface is set by controlling the number and size of the perforations. With the method according to WO 02/12068 only a limited number of synthetic foils should be available in stock, since the perforations are only punched at the start of the packaging process.

EP 1 857 812 relates to a quality control system for monitoring a parameter of holes formed in a film, especially a flexible packaging film. The system comprises a digital camera to form successive images of the holes in the film while the film is fed past the camera. These images are captured and parameters of the holes are analysed in an analyser so as to determine whether or not the parameters meet predetermined quality standards, and a warning is triggered by the analyser if the quality standards are not met. The warning signal may also be used to control the perforator so as to on-line correct for quality variations in hole size and frequency.

WO 2006/063609 relates to a device for perforating a flexible film by means of a laser beam, comprising a laser beam generator, transport means for transporting the flexible film through the laser beam and focusing means for focussing the laser beam on the film surface. A detector is positioned along the path of movement of the flexible film for detecting whether the perforation has been made in the correct way.

WO2009/132663 relates to a process for making perforations in a plastic film material to be used in a package for products prone to decay, in which the surface area of the perforations made in a defined surface area of the plastic film material must have a predetermined value. The process involves making one or more perforations, measuring the surface area of the perforation(s), calculating the difference between the predetermined value and the actual surface area and adjusting the number of perforations based on this difference.

The above publications relate to quality control during production. Prior to production, the perforating beam must be focused on the surface of the film. In practice, this is done by making perforations in a first part of the film, removing the film from the apparatus, checking the perforations under a microscope, adjusting focus, and repeating these steps until adequate focus is reached. This procedure may take up e.g. 20% of the total time needed to produce a batch of perforated film.

It is an object of the present invention to improve adjusting focus prior to production, in particular to reduce the time involved and preferably also to obtain more accurate focus.

To this end, the apparatus according to the invention is characterized by a controller connected to the laser device and the detector and arranged to adjust, preferably prior to production, the focal point of the laser device based on the parameter(s) measured by the detector.

Thus, the in-line detector already present in most cases is employed to focus the laser device and the time required to adjust focus is significantly reduced.

In an embodiment, the controller is arranged to vary the focal point of the laser device in a plurality of increments, typically discrete and equidistant positions, and operate the laser device to make at least one perforation at each increment. In a further embodiment, the controller is arranged to calculate an average and/or standard deviation of the values of the parameter(s) measured at each increment and/or over a range of increments. In particular, the increment where the standard deviation of the parameter, such as the diameter, surface area and/or circumference of the perforations, is smallest was found to provide good results during subsequent production.

In a relatively straightforward embodiment, the detector and the laser device are coupled such that their focal points are on a line that extends parallel to the packaging material. I.e., when the packaging material is in focus of the detector it is also in focus of the laser device.

In a further embodiment, the apparatus comprises a controller connected to the laser device and the detector and arranged to adjust the power of the laser device based on the parameter or one or more of the parameters. This controller and parameter(s) may be the same controller and parameter(s) as those employed for adjusting focus, but may as well be a different controller and/or parameter dedicated to at least this function.

Adjusting power in this way facilitates finer adjusting during production as, for instance, disclosed in WO 2009/132663.

In an embodiment, the controller is arranged to vary the power of the laser device in a plurality of increments and operate the laser device to make at least one perforation at each increment.

The invention also relates to a method of adjusting an apparatus as described above comprising the steps of making a plurality of perforations in the material by means of the laser device, measuring one or more parameters of the perforations with the in-line detector, and adjusting, preferably prior to production, the focal point of the laser device based on the parameter.

In an embodiment, the method comprises varying the focal point of the laser device in a plurality of increments, typically positions relative to the packaging material, determining at which increment the packaging material is in focus of the beam, and adjusting the focal point of the laser device to that increment.

The invention will now be explained in more detail with reference to the Figures, in which

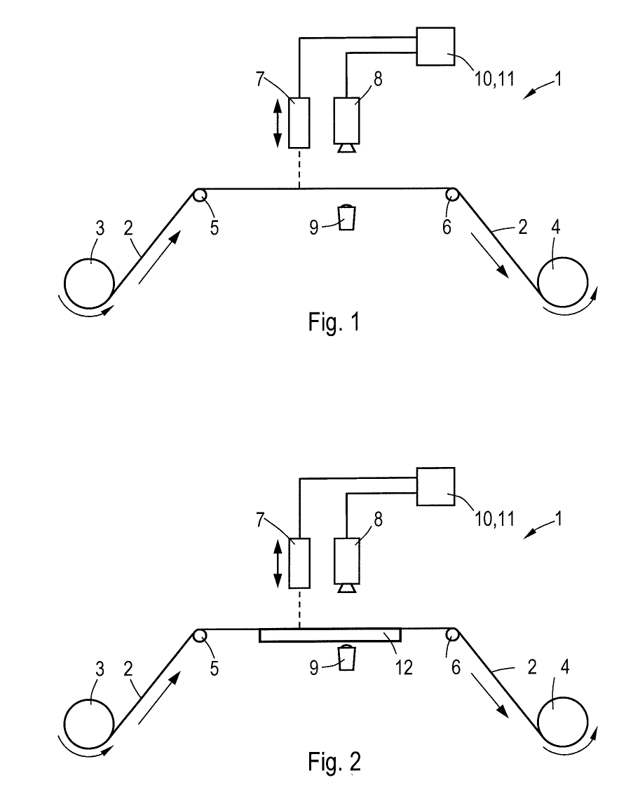

FIG. 1 shows an apparatus for making perforations in a packaging material;

FIG. 2 shows an alternative embodiment of an apparatus, comprising a guide;

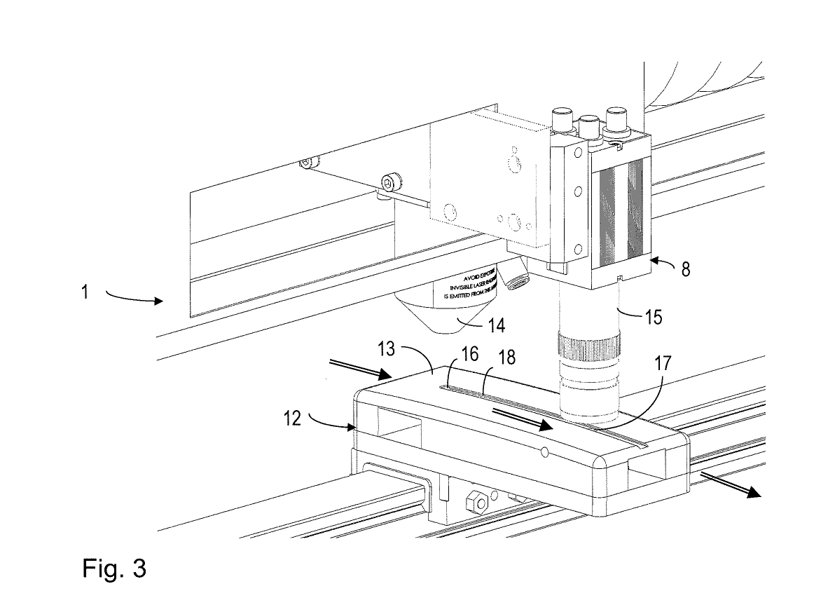

FIG. 3 is a detail of the embodiment of FIG. 2.

In the following, like elements and aspects carry like reference symbols.

FIG. 1 shows a preferred apparatus 1 for making perforations in a packaging material, in particular a polymer film 2, comprising a supply reel 3, a take-up reel 4, and guides 5, 6 together defining a conveyor for transporting the film 2 along a path through the apparatus 1. Suitable polymer films are generally known and include films made of polyethylene, polypropylene, polyester, polyamide, and cellophane, in monolayers and laminates.

The apparatus 1 further comprises a laser device, in this example a laser device 7, with adjustable focal point, and an in-line detector, in this example a digital camera 8, for measuring one or more parameters of the perforations made with the laser. A light source 9 is positioned opposite the digital camera 8, i.e. on the other side of the film, to improve the signal to noise ratio of the information obtained with the camera. The laser device 7 and the digital camera 8 are connected to a controller 10. In this example, the laser device comprises a lens and the focal point of the laser device can adjusted by moving the lens up or down, e.g. by rotating it. In an alternative embodiment, the entire laser device can be moved up and down (as indicated by the double arrow).

When a new roll of packaging film has been positioned on the supply reel and fed through the apparatus along the conveyor path to the take-roll, a pre-production run is started, wherein by means of the controller the position of the focal point of the laser device is varied with respect to the packaging material in a plurality of increments, in this example twenty steps of 10 μm each, and the laser device is operated to make a plurality of perforations, e.g. five perforations at each increment. Within the framework of the present invention, the perforations typically have a diameter in a range from 25 to 250 μm, which are common sizes for packages containing average amounts, e.g. two to four portions, of produce, e.g. lettuce or broccoli.

A digital image is formed of each of the perforations and the surface area of each of the perforation is measured by counting the image pixels defining the perforation. Subsequently, the controller calculates the standard deviation of the surfaces of the perforations at each increment. If few, e.g. one or two, perforations are made at each increment or more information is needed for other reasons, the controller calculates the standard deviation of the surfaces of the perforations over a range of increments, e.g. by including at each increment the surfaces measured at the previous and the next increment. After that, the controller determines at which increment the standard deviation of the measured parameter is smallest and adjusts the focus of the laser device to the position relative to the film where the standard deviation is smallest. The laser beam is now properly focussed on the film.

In a next step, the intensity of the laser beam is adjusted. If the surface area of the holes is smaller or larger than a preselected value appropriate for the packaging material concerned, the power of the beam is increased or decreased respectively in one or more increments until the preselected size is obtained. When the preselected size is obtained, production commences. During production, the camera and the controller continuously monitor and adjust the power of the laser to obtain perforations of the preselected size.

This example illustrates how focussing of the beam and adjusting the power of the beam is carried out by means of the in-line digital camera. The time required to adjust focus is significantly reduced and uniformity of the perforations is increased.

FIGS. 2 and 3 show an apparatus 1 comprising an optional support 12 in the conveyor path (indicated with open arrows in FIG. 3) having a surface 13. FIG. 3 shows the support 12, a lens 14 of the laser device 7 and the camera 8 comprising a lens 15.

At least a portion of the film 2 is guided over and supported by the surface 13 of the support 12 at or near the position of the laser 7 and/or the camera 8, preferably in both positions as shown here. Thus, definition of the position of the film 2 with respect to the position of the laser focus and/or the camera focus is improved.

Preferably, the film 2 is taut over the support 12, for which (part of) the support 12 and/or one or more guides 5, 6 may be adjustable, e.g. in height and/or parallel to the film 2, e.g. for particular films and/or positions of (the holes in) the film 2.

The supporting surface 13 of the support 12 may have a predetermined curvature. The (supporting surface 13 of the) support 12 preferably comprises a smooth, hard and/or low friction surface, e.g. comprising polished metal, high-density polyethylene (HDPE) and/or polytetrafluorethene (PTFE, Teflon®) and may have rounded edges. This may prevent harming the film 2 (see FIG. 3).

FIG. 3 shows a recess or an opening 16 in the support receiving the beam of the laser 7, preventing interaction between (the surface 13 of) the support 12, the laser focus and/or (molten) material of the film 2, also providing eye safety for an operator of the apparatus 1.

A further opening 17 in (the surface of) the support 12 is arranged below the camera lens 15 with the light source 9 arranged below it, possibly within the support 12 (not shown), so as to provide optical access to the film 2 from both upper and lower sides. The light source 9 may be arranged remote from the camera 8 and an optical beam line may be provided, e.g. one or more mirrors, light guides and/or optical fibers to deliver the light to the desired position, e.g. to prevent interaction between the light source and the film, e.g. heat from a lamp which might affect the film 2. A light-emitting diode (LED) may provide strong illumination at little generated heat and in a small volume and may be arranged in the support 12.

The support 12 comprises a slot 18 in or through the support surface 13, which is arranged along at least part of the intended path of a perforation and which crosses the laser beam, overlapping its position, and which preferably has dimensions wider than that of the diameter of the perforations to be made. This prevents deforming and/or closing perforations by smearing still-molten material from the edges of freshly-made perforations improving quality and repeatability. It also assists providing and maintaining a clean support surface 13 and film 2.

As an alternative, not shown, instead of a single support 12 two support portions adjacent each other may be provided, which may be separated from each other for forming a slot between them for receiving the laser beam, providing optical access to the film 2 from opposite sides and/or preventing deforming and/or closing perforations. The support portions may be adjustable individually or together.

The invention is not restricted to the above-described embodiments which can be varied in a number of ways within the scope of the claims.

1. Apparatus for making perforations in a packaging material, in particular a polymer film, comprising:
a conveyor for transporting the material along a path through the apparatus,
a laser device with adjustable focal point, and
an in-line optical detector for measuring one or more parameters of the perforations made with the beam,
wherein a controller is connected to the laser device and the detector and the controller is arranged to adjust the focal point of the laser device based on the parameter(s).

2. Apparatus according to claim 1, wherein the controller is arranged to vary the focal point of the laser device in a plurality of increments and operate the laser device to make at least one perforation at each increment.

3. Apparatus according to claim 2, wherein the controller is arranged to calculate an average and/or standard deviation of the values of the parameter(s) measured at each increment and/or over a range of increments.

4. Apparatus according to claim 1, wherein the detector and the laser device are coupled such that their focal points are on a line that extends parallel to the packaging material.

5. Apparatus according to claim 1, comprising a controller connected to the laser device and the detector and arranged to adjust the power of the laser device based on the parameter or one or more of the parameters.

6. Apparatus according claim 5, wherein the controller is arranged to vary the power of the laser device in a plurality of increments and operate the laser device to make at least one perforation at each increment.

7. Apparatus according to claim 6, wherein the controller is arranged to adjust the power of the laser device also during production.

8. Apparatus according to claim 1, wherein the parameter is or includes the diameter, surface area and/or circumference of the perforations.

9. Apparatus according to claim 1, wherein the detector comprises a digital camera.

10. Apparatus according to claim 1, comprising a support for supporting the polymer film at or near the position of the laser and/or the camera.

11. Apparatus according to claim 10, wherein the support comprises a supporting surface having a predetermined curvature.

12. Apparatus according to claim 10, wherein the support comprises a slot in or through the support surface, which is arranged along at least part of the intended path of a perforation and crossing the beam.

13. Method of adjusting an apparatus for making perforations in a packaging material, in particular a polymer film, comprising the steps of
making a plurality of perforations in the packaging material by means of the laser device,
measuring one or more parameters of the perforations with the in-line detector, and
adjusting the focal point of the laser device based on the parameter.

14. Method according to claim 10, comprising varying the focal point of the laser device in a plurality of increments
determining at which increment the packaging material is in focus of the laser device, and
adjusting the focal point of the laser device to that increment.

15. Method according to claim 10, comprising calculating an average and/or the standard deviation of the values of the parameter(s) measured.

16. Method according to claim 10, comprising, adjusting the power of the laser device based on the parameter or one or more of the parameters.

17. Method according to claim 13, comprising varying the power of the laser device in a plurality of increments and determining at which increment the perforations have a preselected size.

18. Method according to claim 10, wherein the parameter is or includes the diameter, surface area and/or circumference of the perforations.

19. Method according to claim 16, wherein adjusting the power of the laser device is performed after adjusting the focal point of the laser device.
